(19) United States
(12) Patent Application Publication
(10) Pub. No.: US 2015/0151844 A1
(43) Pub. Date: Jun. 4, 2015

(54) HYBRID AIRCRAFT

(71) Applicant: Siemens Aktiengesellschaft, München (DE)

(72) Inventors: Frank Anton, Erlangen (DE); Swen Gediga, Hochstadt/Aisch (DE); Johannes Wollenberg, Grafelfing (DE)

(73) Assignee: Siemens Aktiengesellschaft, München (DE)

(21) Appl. No.: 14/407,395

(22) PCT Filed: May 16, 2013
(86) PCT No.: PCT/EP2013/060170

§ 371 Date: Dec. 11, 2014

(30) Foreign Application Priority Data
Jun. 12, 2012 (DE) 10 2012 209 807.0

(51) Int. Cl. B64D 27/24

(52) U.S. Cl. CPC B64D 27/24; B64D 2027/026

(57) ABSTRACT

The invention relates to a hybrid aircraft (F). According to the invention, a suitable position for mounting an energy generation unit (14) in the aircraft is identified, said energy generation unit comprising an internal combustion engine (34) and an electric generator (30) that is coupled thereto via a shaft. Independently of the position of the energy generation unit (14), a position is also identified for a thrust generation unit (12) comprising an electric motor (24) and a propeller (20) that is coupled thereto via a shaft (22). When the aircraft (F) is built, the thrust generation unit (12) and the energy generation unit (14) are disposed in the positions identified therefor. The generator (30) is then coupled to the electric motor (24) via an electric transmission device (16).

The invention relates to an aircraft and to a method of manufacturing an aircraft. The aircraft has an internal combustion engine by means of which drive power for driving a propeller of the aircraft is able to be created. An aircraft is especially to be understood as a motor-driven fixed-wing aircraft. However the term aircraft also includes rotorcraft (rotor aircraft, helicopter) and powered sailplanes.

In today's aircraft with propeller drive, such as light aircraft for example, an internal combustion engine, for example a piston engine or a turbine drive, is coupled rigidly to the propeller either via a shaft or via gearing in order to drive said propeller. Because of the mechanical coupling between internal combustion engine and propeller, the aircraft drive formed in this way is mounted on the aircraft as a concentrated unit, mostly on a wing or on the tip of the fuselage. These positions have proved to be a good compromise to harmonize with one another the construction criteria relating to the position of the propeller on the one hand and also those of the position of the internal combustion engine on the other hand. The flow losses taken into account with the compromise are compensated for in such cases by an internal combustion engine with a correspondingly high power. However this leads to a correspondingly high fuel consumption of the aircraft.

Publication DE 10 2011 103 572 A1 describes a self-launching sailplane having a rechargeable DC voltage source and an electric drive with at least two electric motors, to drive a one propeller each. The sailplane can also have an internal combustion engine with an electric generator coupled thereto for charging the DC voltage source during the flight. The internal combustion engine and the electric generator together form an emergency power plant. During the flight the electric motors are supplied with energy from the rechargeable DC voltage source. When the operating voltage of the DC voltage source falls below a predetermined value, the power drawn off must be reduced or the DC voltage source must be recharged by means of the emergency power plant.

Publication U.S. Pat. No. 2,462,201 A describes an aircraft with an electrically-driven propeller and a generator driven by a turbine. The generator and the electric motor for the propeller are coupled directly via a 3-phase generator bus. The generator and the turbine are disposed close to the center of gravity of the aircraft.

Publication U.S. Pat. No. 4,605,185 A describes an aircraft with electrically-driven propellers which obtain their electric energy from a generator which is driven by an internal combustion engine. The internal combustion engine is so powerful that the aircraft can fly at a higher speed than normal. In the event of the internal combustion engine failing a battery is provided for power supply which makes emergency operation of the electric motors possible.

Publication DE 10 2008 014 404 A1 describes an aircraft with a hybrid drive, wherein an internal combustion engine drives a generator for power generation and the power feeds an electric motor functioning as a primary drive and/or a storage battery, wherein the electric motor can also be fed with power from the storage battery. The electric motor is fed from the storage battery if the internal combustion engine fails, for which the storage battery is embodied such that a safe landing of the aircraft is always guaranteed by the battery being designed so that a remaining flight time of 15 minutes is made possible.

Publication WO 2011/144690 A1 describes a helicopter in which rotors are driven by electric machines, wherein the electric energy required for this purpose is created via a motor-generator unit. Furthermore the electric energy created by the generators can be output to an electric store so that the buffered energy from said store can be used for emergency supply of the electric machines if one or more of the internal combustion engines of the motor-generator units fail. The buffered energy can also be used to service peaks in the required power of the electric machines.

Publication DE 195 25 267 C2 describes a drive which uses hydrogen as its energy source which is created directly if required or by a reaction of lithium, sodium and other basic elements as well as water and is then converted into drive energy with the aid of the drive unit such as a gas turbine or a diesel engine or a thermal engine with generator.

Publication WO 2011/144696 A1 describes a tilt wing aircraft in which the power necessary for driving the aircraft is provided for all propellers by a shared motor or turbine unit and the power is then distributed optimized according to the mission task via an electric coupling to be propellers which are driven by electric motors.

Publication U.S. Pat. No. 1,511,448 A describes an aircraft with electrically-driven propellers, wherein the electric drive motor obtains its energy from a generator which is driven by a motor. The motor can be disposed in the nose of the aircraft while the propellers with the electric motors can be mounted on the wings.

Publication U.S. Pat. No. 4,554,989 describes a helicopter of which the rotor is electrically driven, wherein a generator creates the necessary electric energy for driving the rotor. The generator is driven by a turbine of which the exhaust air shaft is opened towards the top.

Publication DE 10 2010 021 026 A1 describes a hybrid drive and energy system for aircraft. An energy generation system delivers electric energy via an inverter to a first electric motor of a main rotor of a helicopter. The energy generation system can comprise a Wankel engine and a generator for example. In cruising flight of the helicopter, when the power demand for the electric motor of the main rotor is not as great as during takeoff, the additional power of the energy supply system thus available can be used for charging the battery.

Publication US 2011/0089290 A1 describes an aircraft with jet engines which are arranged above wing surfaces in order in this way to reduce an emission of sound from the engines to the ground.

Publication DE 27 20 957 A1 describes powered sailplanes having propeller drives which are mounted at different positions, in order in this way to make possible a simple aerodynamic design of the respective aircraft and obtain a practical center of gravity of the aircraft.

Publication DE 32 45 011 A1 describes a sailplane with a detachable auxiliary power plant. The auxiliary power plant can also involve an electric motor with propeller driven by electric batteries.

An object of the invention is to create a greater degree of constructional freedom during manufacturing of an aircraft in the determination of suitable positions both for the propeller and also for the internal combustion engine.

The object is achieved by an aircraft as claimed in claim 1. Advantageous developments of the invention are provided by the dependent claims.

The invention makes possible a sensible distribution of the individual components of the aircraft drive in or on the aircraft. To this end the internal combustion engine is not provided as a mechanical drive for the propeller but as a component of an energy generation unit which, as well as the internal combustion engine, also has an electric generator coupled to said engine via a shaft. Thus electric energy is first generated with the internal combustion engine. The propeller is now provided as a component of a thrust creation unit which, as well as the propeller, also comprises an electric motor which is coupled to said propeller via a shaft.

To make it possible to operate the electric motor the thrust creation unit and the energy generation unit are coupled to each other electrically. For this purpose the generator is coupled to an electric motor by means of an electric transmission device. Unlike a shaft for mechanical coupling, this electrical transmission device can comprise flexible cables, via which electric power can be transmitted from generator to electric motor. The relative position of the energy generation unit and the thrust creation unit in relation to one another can thus be freely selected. Additional degrees of constructional freedom are produced which make it possible in the construction of the aircraft to define the position of the thrust creation unit independently of the position of the energy generation unit. Accordingly the invention makes provision, for manufacturing an aircraft, for determining a position for the energy generation unit at which the energy generation unit can be arranged in the aircraft. The position for the thrust creation unit is determined in this case independently of the position of the energy generation unit. After they have been arranged in the aircraft at the position determined for them in each case, the generator and the thrust creation unit are then coupled electrically via the transmission device.

Overall this advantageously enables a spatial distribution of the drive components to be selected more freely.

The inventive aircraft according to the invention has a thrust creation unit of the said type as well as an energy generation unit of the said type. Furthermore the inventive aircraft has the described electric transmission device which is embodied for transmission of electric energy from the energy generation unit to the thrust creation unit. In the inventive aircraft a distance between the thrust creation unit and the energy generation unit now amounts to at least 0.5 m, especially more than 1.0 m, preferably more than 1.5 m. This means that it is possible to place the thrust creation unit at an aerodynamically favorable location on the fuselage of the aircraft or on its wings and at the same time arrange the energy generation unit in the fuselage protected from airflow in a favorable way according to further constructional criteria.

The mechanical decoupling of the thrust creation unit on the one hand and of the energy generation unit on the other hand also has the advantage that an especially cost-effective operation of the internal combustion engine is made possible. To this end the inventive aircraft makes provision for a maximum possible power output of the internal combustion engine to be less than the thrust power (MTOP—Maximum Take-off Power) required for takeoff. In other words the aircraft can have a much smaller internal combustion engine than a conventional aircraft in which the propeller is driven directly via the internal combustion engine, so that said engine also has to be able to produce the MTOP.

A consumption-optimized operation of the internal combustion engine lies at a power output of the internal combustion engine in a range of 100% to 130% of the specified maximum continuous power of the aircraft. The maximum continuous power (MCP) is to be understood as a power value which the aircraft has to be able to create for thrust creation when traveling between the takeoff phase and the landing phase. The MCP lies as a rule between 30% and 70% of the MTOP. For an internal combustion engine operation at maximum efficiency is generally produced close to the maximum power output. In that the maximum power output can now be less than the MTOP, operation at maximum efficiency close to the MCP can be selected. Through the selection of the maximum possible power output in the range of between 100% to 130% of the MCP, i.e. greater than 100%, it is further possible for a battery to be charged as well during the flight. Such a battery can then be used to provide the additional power needed for producing the MTOP.

In this connection the inventive aircraft makes provision for there to be at least one further energy supply device for supplying the thrust creation device with additional electric energy, wherein the at least one further energy supply device comprises a battery or a fuel cell. The at least one further energy supply device can e.g. be arranged in a wing of the aircraft. Through a battery or a fuel cell the energy supply device can be supported during takeoff of the aircraft in order to provide the MTOP needed. Also no additional noise is produced by this process.

Preferably a position is determined for the thrust creation unit through which at least one, preferably at least two of the following conditions are fulfilled during flight.

The first condition says that there is a free air flow onto the propeller. A free airflow is produced if there is no further component of the aircraft in the longitudinal direction of the aircraft in front of the propeller which significantly influences the flow of the air flowing towards the propeller.

The second condition says that an air flow created by the propeller flows away freely. Flowing away freely is to be understood as the air flowing away accelerated by the thrust creation unit not striking any further component of the aircraft which significantly adversely affects the airflow. In current aircraft the airflow generally strikes the fuselage of the aircraft (propeller on the nose) or a wing, which significantly adversely affects the lift and propulsion compared to a free-flowing air flow.

Improving the flow onto and/or away from the propeller produces a more favorable aerodynamic, which for example makes it possible to build the aircraft with comparatively short wings, which in turn reduces the fuel consumption. Thus correspondingly, in accordance with a form of embodiment of the inventive aircraft, there is provision for the thrust creation unit to be arranged between wings of the aircraft and a tailplane assembly of the aircraft. This arrangement fulfils both the condition of free flow of air onto the unit and also away from the unit.

The third condition says that a drive force created by the thrust creation unit is transmitted, in a specific area to the fuselage of the aircraft. By contrast with a prior-art aircraft, the lighter-weight thrust creation unit consisting of propeller and electric motor can be mounted at many more different locations on the aircraft fuselage or on a wing, without this making too great a demand on the static system of the aircraft. Thus the connection point of the thrust creation device for transmitting the thrust into the fuselage of the aircraft can also be better selected. With an aircraft in accordance with the prior arms in which the weight of the internal combustion engine also has to be taken into account, one is forced on the other hand to adapt the position of the propeller to the static system of the aircraft.

Similarly to the case of selecting the position for the thrust creation unit, the invention makes provision for determining a position for the energy generation unit which fulfils at least one, preferably at least two of the following conditions for flight operation.

The first condition says that vibrations emanating from the energy generation unit to the fuselage can only be transmitted up to a predetermined level. Since the alignment of the internal combustion engine and of the generator in relation to the thrust creation unit can be selected entirely freely, there is now a far greater degree of freedom to avoid the transmission of vibrations into the aircraft fuselage, for example by selecting a corresponding position of the energy generation unit or by supporting the energy generation unit on a vibration-damping material.

To this end a form of embodiment of the inventive aircraft also makes provision for an axis of rotation of the shaft of the energy generation unit to be arranged transversely to a normal direction of flight of the aircraft. Thus the vibration forces of the internal combustion engine usually acting transverse to the axis of rotation are able to be aligned in the longitudinal direction to the aircraft fuselage. The longitudinal rigidity of the aircraft fuselage is greater as a rule than the transverse rigidity. For this reason only a small proportion of the vibrations is then transferred to the aircraft fuselage.

The second condition says that a predetermined proportion, e.g. 50% or 70%, of the sound created by the energy generation unit will be emitted upwards from the aircraft. This condition too can now also be fulfilled much more easily in that the location of the energy generation unit is selected accordingly in the aircraft fuselage or a sound conducting device for emitting sound created by the energy generation unit upwards away from the aircraft can even be provided. Such a sound conducting device can be a channel for conducting the sound away upwards for example.

In accordance with the third condition the weight of the energy generation unit at least partly balances out the weight of the thrust creation unit. The balancing out here is undertaken in relation to the overall center of gravity of the aircraft. Accordingly a form of embodiment of the inventive aircraft makes provision for an overall center of gravity of the aircraft to be arranged between a center of gravity of the energy generation unit and a center of gravity of the thrust creation unit. The balancing out has the advantage that the aircraft can have a shorter fuselage. In aircraft from the prior art, with a compact layout of the aircraft drive of propeller and internal combustion engine in the nose on the other hand, the weight of this drive must be arranged on one side of the overall center of gravity and therefore balanced out by a correspondingly extended fuselage.

In order to transmit the electric energy generated by the energy generation unit to the thrust creation unit, the electric transmission unit is provided in the inventive aircraft. This unit extends the distance mentioned above. In a simple form of embodiment there can be provision for the alternating current generated by the generator to be transferred directly to the electric motor and to drive said motor. In this case the speed of the electric motor is then dependent on the speed of the generator.

Preferably however there is provision for the transmission device to have a DC link to which the generator is coupled via a rectifier. A DC link here is to be understood as an arrangement of the electric conducting elements, e.g. cables and/or bus bars, via which the rectified voltage is transmitted. The advantage of a DC link lies in the fact that the speed of the electric motor and the speed of the generator are independent of one another.

A converter for operating the electric motor is preferably arranged in the aircraft fuselage in this case, i.e. not directly on the electric motor. This improves the aerodynamics of the aircraft. On the other hand if there is a need for cooling power for the converter, said converter is expediently arranged outside the aircraft fuselage. The converter can also advantageously be integrated into the electric motor.

The separation of the aircraft drive into thrust creation unit on the one hand and energy generation unit on the other hand produces the further advantage of a further thrust creation unit also being able to be operated with one and the same energy generation unit. Accordingly a form of embodiment of the inventive aircraft makes provision for at least one further thrust creation unit to be provided, which is likewise coupled electrically by the transmission device to the energy creation unit. Unlike in conventional aircraft, in this form of embodiment only one the internal combustion engine has to be provided. This simplifies finding a position for the energy generation unit at which as few vibrations as possible are transmitted to the aircraft fuselage and/or as little sound as possible is emitted downwards. A number of thrust creation units arranged optimally in accordance with aerodynamic considerations can then be operated in the aircraft/on the aircraft by means of the one energy generation unit. Because of the generally small designs of electric motor it is especially also possible to operate a number of small propellers and to find correspondingly favorable positions for said propellers. For example 4 or even 8 propellers can be provided, which then create a thrust which can then be very much more evenly distributed than the thrust from only two propellers.

In the realization of an inventive aircraft there is great flexibility in relation to the choice of propeller. The propeller can for example be a free-running propeller or a ducted propeller. A free-running propeller is to be understood here as the blade tips of the propeller, unlike those of a ducted propeller, not being enclosed by a further component of the propeller.

There is also a very free choice of electric motor for the thrust creation unit. In principle any type of electric machine is able to be used, i.e. an asynchronous machine, a synchronous machine or a DC motor for example. A permanent magnet-excited synchronous machine has proved to be especially suitable.

In accordance with a form of embodiment of the inventive aircraft the thrust creation unit also has gearing, via which the electric motor is coupled to the propeller. This enables a comparatively slowly turning propeller to be used and a favorable speed still to be selected for the design of the electric motor. In precisely the same way with the energy generation unit the internal combustion engine can be coupled via gearing to the electric generator.

The invention will be explained once again in greater detail below with reference to an actual exemplary embodiment. In the figures:

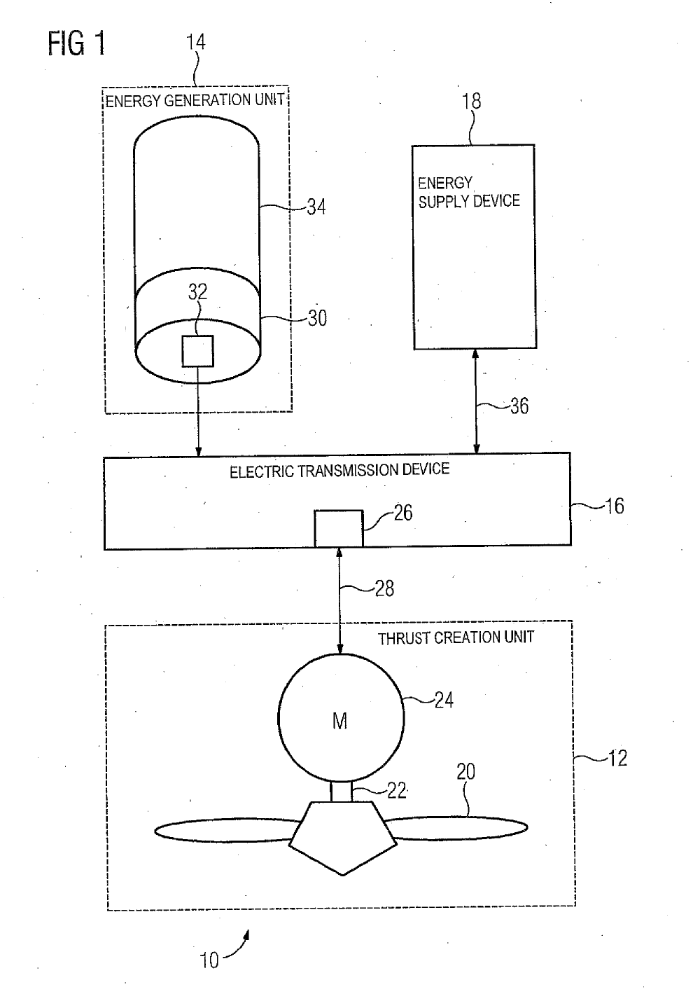

FIG. 1 shows a schematic diagram of an aircraft drive device of a preferred form of embodiment of the inventive aircraft, and

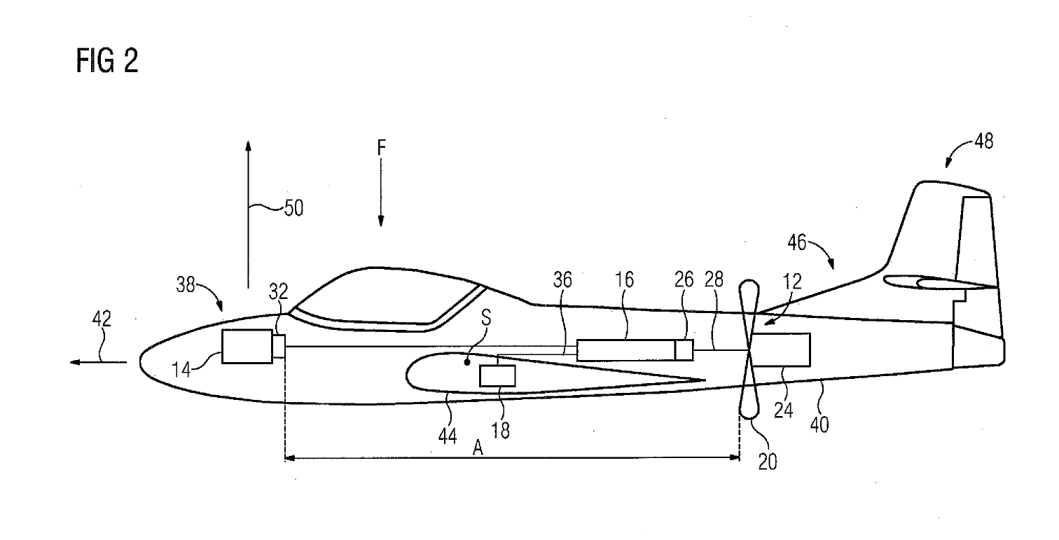

FIG. 2 shows a schematic diagram of a form of embodiment of the inventive aircraft.

In the example explained below the described components of the aircraft each represent individual features of the invention to be considered independently of one another, which also develop the invention in each case independently of one another and are thus also to be viewed individually or also in a combination other than the one shown as a component of the invention. Furthermore the described form of embodiment is also able to be expanded by further features of the invention already described.

FIG. 1 shows an aircraft drive 10 having a thrust creation unit 12, an energy generation unit 14, power distribution electronics which represent an electric transmission device 16, and a battery arrangement 18. The transmission device 16 can have a DC link circuit as well as rectifiers and inverters for exchanging electric energy with the DC link circuit. The aircraft drive 10 can be built into an aircraft for example. The thrust creation unit 12 has a propeller 20 which is coupled via a shaft 22 to an electric motor 24. The electric motor 24 turns the shaft 22 and thus drives the propeller 20 rotationally. The electric motor 24 can additionally be coupled via gearing to the propeller 20.

A speed and a torque which the electric motor 24 creates in this case are set by a converter 26 in the way known per se. Through the converter 26 an alternating current with variable frequency is set in a multiphase cable 28. For this purpose the converter 26 receives switching signals from a control device (not shown).

The converter converts an electric DC voltage which it taps from electric conductors (not shown) of the DC link circuit of the transmission device 16 into the AC voltage in the cable 28. The DC voltage of the DC link circuit of the transmission device 16 involves a rectified voltage which is generated by the energy generation unit 14. For this purpose the energy generation unit 14 has an electric generator 30 which is coupled by a rectifier 32 to the DC link circuit of the transmission device. The generator 30 is driven by the internal combustion engine 34, for example a Wankel engine, a piston engine or a turbine.

The battery arrangement 18 represents a further energy source for the electric motor 24. The battery arrangement 18 can comprise one or more batteries, each with one or more battery cells. The DC voltage generated by the battery arrangement 18 is fed if necessary likewise via a cable 36 into the DC link circuit of the transmission device 16. This can also be done however via a DC/DC converter for adapting the battery voltage to the DC link voltage. Through an appropriate switching device (not shown) it is also possible in the aircraft drive 10 to charge the batteries of the battery arrangement 18 again by means of the energy generation unit 14. A fuel cell system can also be provided instead of the battery arrangement 18 or in addition to said arrangement.

The aircraft drive 10 can have yet further thrust creation units like the thrust creation unit 12, which can likewise be connected to the DC link circuit of the transmission device 16. The aircraft drive 10 can also be provided by one or more further energy generation units like the energy generation unit 14, which can likewise be connected to the DC link circuit of the transmission device 16.

In the aircraft drive 10 its components, especially the thrust creation unit 12 and if necessary also the further thrust creation unit or further thrust creation units on the one hand and the energy generation unit 14 and if necessary the further energy generation unit or further energy generation units on the other hand do not have to be arranged concentrated into one area of the aircraft, for example in the nose or on a wing. The aircraft drive 10 instead is arranged distributed in the aircraft, as will be explained in greater detail below.

Where precisely the drive components of the aircraft drive 10 are to be arranged in a predetermined type of aircraft can be established in a design and the construction of the aircraft based on suitable simulations and calculations. The distribution of the individual drive components could for example appear as is explained with reference to FIG. 2. In FIG. 2 the aircraft drive 10 is shown once again built into an aircraft F.

The energy generation unit 14 can be arranged in the nose 38 of the aircraft fuselage 14. A crankshaft or the axis of rotation of the crankshaft must point in the direction of flight 42 in this case. The battery arrangement 18 can for example consist of two sub-batteries, which can be arranged in each case in one of the wings 44 of the aircraft F. The converter 32 of the energy generation unit 14 can be disposed in an aircraft fuselage 40. The control device for the converter 26 and the converter 32 can be arranged in the tail 46 (not shown in FIG. 2). The thrust creation unit 12 can be attached to the aircraft fuselage 40 between the wings 44 and a tailplane assembly 48.

A further advantage of the distribution of the drive components is produced if the internal combustion engine 34 is arranged in the aircraft F so that the sound that it emits is directed upwards (direction 50) and thus the noise nuisance on the ground over which the aircraft F is flying is reduced.

A distance A between the thrust creation unit 12 and the energy generation unit 14 amounts in the example shown in FIG. 2 to more than 0.5 m, especially more than 1.5 m. An overall center of gravity S of the aircraft F, which describes the mass center of gravity of all components of the aircraft F together, can be located between the mass center of gravity of the thrust creation unit 12 and a mass center of gravity of the energy generation unit 14, in order to balance out the aircraft.

Distributing the individual drive components (internal combustion engine 34, generator 30, batteries of the battery arrangement 18, control and regulation system (with power electronics) of the transmission device 16, electric motor 24 and if necessary gearing between the electric motor and propeller 20) enables a number of efficiency-enhancing effects to be achieved.

1. The balancing out of the aircraft is simpler since the thrust creation units 12 and the energy generation unit 16 can be arranged on opposite sides of the overall center of gravity of the aircraft. This gives greater degrees of freedom in the arrangement and the proportions of the individual aircraft parts (nose, fuselage, tail, wings, tailplane assembly). In that for example the internal combustion engine 24 and the propeller 20 do not have to be arranged together in the tip of the fuselage in the nose, the tail also does not have to be embodied correspondingly long as a counterweight in order to compensate for this nose-heaviness. A shorter aircraft can then also have shorter wings so that overall an improvement of the lift and the propulsion is produced as a result of the lower air resistance. A particular form of embodiment of the inventive aircraft provides for an embodiment as a wing-only aircraft in which the described drive components can then likewise be more simply distributed than would be the case in an aircraft drive with mechanical coupling of internal combustion engine and propeller.

2. An arrangement of the thrust creation unit (propeller 20 and if necessary further propellers) in areas of the aircraft through which the aerodynamics of the aircraft are disturbed as little as possible is made possible. Thus for example a propeller on a wing disturbs the flow of the wing creating the lift and therefore reduces the desired lift. A propeller is generally arranged on the wing since this represents a favorable static-system location for supporting an internal combustion engine. In the inventive aircraft this boundary condition does not apply since the internal combustion engine 34 can be arranged at a greater distance A away from the propeller 20 in the aircraft F. The thrust creation unit 12 can be mounted constructively very much more easily on the aircraft than a combination of a combustion engine and a propeller. Thus the thrust creation unit 12 can be arranged for example on a bar on the roof of the aircraft at a distance of for example 1.5 m or 2 m or also between the wings and the tailplane assembly. This enables an improvement in lift compared to a conventional aircraft to be achieved.

3. An improvement in propulsion can be achieved by arranging the thrust creator in areas of the aircraft in which an undisturbed flow of air onto and away from the thrust creator is possible. These are likewise the already described locations on a bar or e.g. on the fuselage between the wings and in front of the tailplane assembly if the basic shape of the aircraft fuselage is based on the conventional shape of a cylindrical fuselage with fixed wings arranged centrally and tailplane assembly (cf. FIG. 2). This arrangement makes possible an improvement of the propulsion through a reduced flow resistance.

Overall the example shows how through a spatial distribution of the drive components in an advantageous manner the lift and propulsion of an aircraft can be improved and by this it can be made faster or more efficient in its fuel consumption. Furthermore the distribution provides the opportunity of reducing noise nuisance on the ground through the ability to freely align the internal combustion engine in the aircraft.

What is claimed:

1.-10. (canceled)

11. A motor-driven, fixed-wing aircraft, comprising:
a thrust creation unit including an electric motor, a propeller, and a shaft to couple the propeller to the electric motor;
an energy generation unit spaced from the thrust creation unit by a distance of at least 0.5 m and including an internal combustion engine having a maximum possible power output which is less than the thrust power needed during a take-off of the aircraft, an electric generator, and a shaft to couple the electric generator to the internal combustion engine, said shaft of the energy generation unit being rotatable about an axis of rotation and extending transversely to a specified flight direction of the aircraft, said internal combustion engine being defined by a consumption-optimized operation which lies at a power output of the internal combustion engine in a range of 100% to 130% of a specified cruising power of the aircraft, wherein the aircraft is designed to assist the energy generation unit during takeoff of the aircraft so as to provide thrust needed during takeoff;
an electric transmission device configured to transmit electric energy from the energy generation unit to the thrust creation unit;
at least one energy supply device configured to supply the thrust creation device with additional electric energy and including a battery or a fuel cell; and
a sound conducting device configured to emit sound created by the energy generation unit upwards away from the aircraft and including a channel for directing the sound upwards.

12. The aircraft of claim 11, constructed to define an overall center of gravity arranged between a center of gravity of the energy generation unit and a center of gravity of the thrust creation unit.

13. The aircraft of claim 11, wherein the electric transmission device includes a DC link circuit, said energy generation unit including a rectifier configured to couple the DC link circuit to the electric generator of the energy generation unit.

14. The aircraft of claim 11, further comprising an aircraft fuselage, and a converter arranged in the aircraft fuselage and configured to operate the electric motor of the thrust creation unit.

15. The aircraft of claim 11, further comprising wings and a tailplane assembly, said thrust creation unit being arranged between the wings and the tailplane assembly.

16. The aircraft of claim 11, further comprising a further thrust creation unit coupled electrically via the transmission device to the energy generation unit.

17. The aircraft of claim 11, wherein the propeller is a free-running propeller or a ducted propeller.

18. The aircraft of claim 11, wherein the electric motor of the thrust creation unit is coupled via a gearing to the propeller and/or the internal combustion engine of the energy generation unit is coupled via a gearing to the electric generator.
